(19) United States
(12) Patent Application Publication
(10) Pub. No.: US 2003/0205836 A1
(43) Pub. Date: Nov. 6, 2003

(54) Manufacturing method for environment-friendly food container

(76) Inventor: Chih-Hsiang Chen, Taipei (TW)

Correspondence Address: CHEN, Chin-Hsiang, PO Box 82-144, Taipei, TW

(21) Appl. No.: 10/138,250

(22) Filed: May 6, 2002

(51) Int. Cl. B29C 43/24

(52) U.S. Cl. 264/134; 264/175; 264/140; 427/393.4

(57) ABSTRACT

A manufacturing method for environment-friendly food container is disclosed. The process employs paddy husk or vegetative plant stalks to be crushed or ground into powdery form. These materials are then mixed and stirred with water, oil, surfactant and adhesive. The product is then proceeded to a second stirred mixing process and is then proceeded to a squeezing device to form into plate-like material directly leaded to a pressing device. The plate-like material is then proceeded to a first drying process, a glue-containing process and a second drying process. The material after the second drying process can be used for the fabrication of containers for food.

### BACKGROUND OF THE INVENTION

(a) Field of the Invention

The present invention relates to manufacturing of food container, and in particular, to manufacturing method for environment-friendly container by employing recycled or discarded paddy husk and fibrous plant materials.

(b) Description of the Prior Art

Generally, containers for food, which can be recycled and are available in the market, are rather expensive, and thereof, these containers are not wide used. Besides, the costs of recycling these containers to avoid pollution to the environment are expensive. Accordingly, it is an object of the present invention to provide a manufacturing method for environment-friendly food container, which is cheap in the manufacturing, process and is economical in the recycle process.

### SUMMARY OF THE INVENTION

A main object of the present invention is to provide a manufacturing method for environment-friendly food container comprising the steps of:

(a) preparing raw materials from vegetative fibrous materials such as paddy husk, maize husk, corn husk by crushing or grinding these material until fine particles of size above 30 mesh is obtained, adding with flour, clay or CaCo₃ and grind the mixture until a powdery form is obtained for storage in a storage tank;

(b) mixing the materials obtained in step (a) with pulp slurry, water, oil or active surfactant and preservative in a specific ratio to form into a fluidized material;

(c) a first step mixing the material from step (b) at a rapid speed until a semi-wet material is obtained and then adding with an adhesive, and water, and

(d) a second step mixing the material obtained from step (c) at a slower speed until a paste-like material is obtained, then storing the material in a storage tank;

(e) squeezing the paste material of step (d) using a squeezing device to form a continuous plate-like material;

(f) rolling the plate-like material to form into a thin and wider material;

(g) performing a first step drying at a temperature of 140° C.;

(h) coating the product of (g) with glue on the surface until a water proof effect is obtained;

(i) performing a second step drying at 120° C. so that the surface with glue is dried for manufacturing of container; and

(j) rolling the product obtained in step (i) in rolls or directly proceeding the material to form containers.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart showing the manufacturing method for environment-friendly food container in accordance with the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

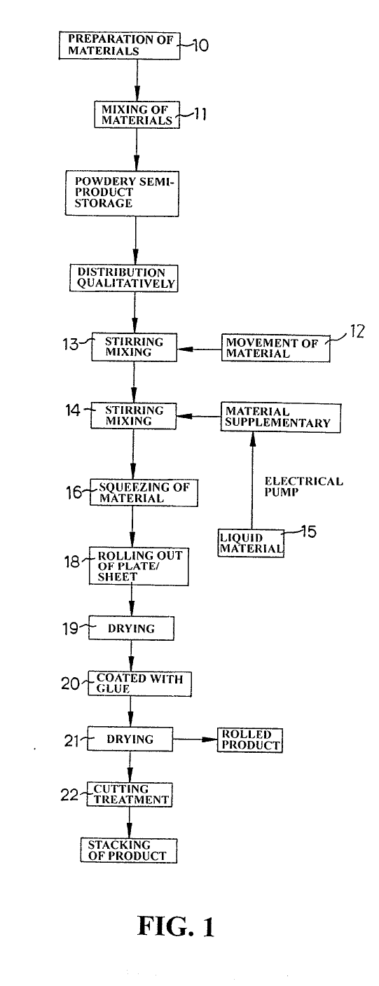

Referring to FIG. 1, there is shown a manufacturing method for environment-friendly food container. In accordance with the present invention, a preparation of raw material process 10 is first performed by employing vegetative fibrous materials such as paddy husk, wheat husk, maize husk and hay and other vegetative stalks. These materials are crushed or ground until particles of sizes having mesh of 60 are obtained. Flour, clay or white ash or calcium carbonate are prepared and ground and are stored in a storage tank. The above materials are then mixed together for treatment at mixing process 11. That is, the materials are mixed in a specific ratio to form a solid, powdery material for storage. Next, pulp slurry or water, oil, active surfactant and preservatives are mixed in a specific ratio until a fluidized material 12 is formed. The solid material and the fluidized material are mixed in a specific ratio and placed in a stirring tank to proceed with a first stirring and mixing treatment 13. The mixing treatment 13 is proceeded slowly, at a speed of 300 rpm or above for 5 minutes. The semi product of the first stirring mixing treatment 13 is a semi-wet product. This semi-wet product is added with an appropriate ratio of liquid material 15. That is, adhesive is prepared by adding PVA and water, and is directly placed into the stirring tank for second time stirring mixing treatment 14. The stirring speed is about 20 rpm and the stirring time is about 3 to 10 mins, so that the product becomes a paste-like material. At this stage, the materials for the manufacturing are completed.

The paste-like material of the second time stirring mixing treatment 14 is directly added to the storage tank. A control valve is used to control the output of the material in a specific volume. This will interlink to the material discharge in a material squeezing process 16 from a material squeezing device. This process continuously provides material for the operation and the material is formed into a plate-like or strap material. The plate-like material is pulled into a pressing device to proceed with roll-and-press plate 18. The specific thickness and width of the roll-and-press plate 18 is obtained and the plate 18 is directly placed into a drying device to process with a drying process 19. Generally, hot wind of 140° C. is used for this process and the dried plate is directly proceeded to a glue coating process 20. This can be carried out by spraying or adhesion so that the surface layer is formed into a water impermeable film, providing waterproof function for a second time drying process 21 with a hot air of 120° C. The upper, glue-coated layer is rapidly dried and thus material for fabrication of containers is thus obtained and is rolled into rolls or directly proceeded for a cutting process 22. That is, a cutter is used to cut the material based on specific dimension, facilitating fabrication process to obtain containers.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spit of the present invention.

I claim:

1. A manufacturing method for environment-friendly food container comprising the steps of
(k) preparing raw materials from vegetative fibrous materials such as paddy husk, maize husk, corn husk by crushing or grinding these material until fine particles of size above 30 mesh is obtained, adding with flour, clay or CaCo₃ and grind the mixture until a powdery form is obtained for storage in a storage tank;
(l) mixing the materials obtained in step (a) with pulp slurry, water, oil or active surfactant and preservative in a specific ratio to form into a fluidized material;
(m) a first step mixing the material from step (b) at a rapid speed until a semi-wet material is obtained and then adding with an adhesive, and water, and
(n) a second step mixing the material obtained from step (c) at a slower speed until a paste-like material is obtained, then storing the material in a storage tank;
(o) squeezing the paste material of step (d) using a squeezing device to form a continuous plate-like material;
(p) rolling the plate-like material to form into a thin and wider material;
(q) performing a first step drying at a temperature of 140° C.;
(r) coating the product of (g) with glue on the surface until a water proof effect is obtained;
(s) performing a second step drying at 120° C. so that the surface with glue is dried for manufacturing of container; and
(t) rolling the product obtained in step (i) in rolls or directly proceeding the material to form containers.

2. The method of claim 1, wherein the adhesive is obtained from the preparation of PVA with water.

3. The method of claim 1, wherein the speed of stirring at the first step stirring is above 300 rpm.

4. The method of claim 1, wherein the speed of stirring at the second step stirring is above 20 rpm.

5. The method of claim 1, wherein the method of coating with glue is by means of spraying or adsorption.
